(19) United States
(12) Patent Application Publication
(10) Pub. No.: US 2020/0114182 A1
(43) Pub. Date: Apr. 16, 2020

(54) CLIMBING WALL COMPRISING TRACK-BASED SUPPORT HARNESS

(71) Applicant: Everlast Climbing Industries, Inc., Minneapolis, MN (US)

(72) Inventors: Timothy Shawn Sudeith, Edina, MN (US); Sarah Mae Howard, Lakeville, MN (US); Joel Greenblatt, Wauwatosa, WI (US); Joseph Sweeney, Minneapolis, MN (US); Aaron Jon Baumgartner, Savage, MN (US)

(21) Appl. No.: 16/598,494

(22) Filed: Oct. 10, 2019

Related U.S. Application Data
(60) Provisional application No. 62/743,643, filed on Oct. 10, 2018.

(51) Int. Cl. A62B 35/00; A63B 69/00; A62B 1/08; A63B 29/02

(52) U.S. Cl. CPC A62B 35/0056; A63B 69/0048; A62B 35/0062; A63B 29/02; A62B 35/005; A62B 1/08

(57) ABSTRACT

The present invention is directed to a climbing wall comprising a climbing surface and a climbing assistance assembly that provides a disabled child with an opportunity to utilize the climbing wall. The climbing assistance assembly comprises a track mounted above at least a portion of the climbing surface and spanning at least a portion of the length of the climbing surface. A trolley, from which a rope is suspended, is configured to travel along the track. The rope is coupled both to the trolley and to a harness. The climbing assistance assembly may further include a fall arrest device configured to lower an end of the rope coupled to the harness from an elevated position to a rest position in a controlled manner. Because the trolley is configured to travel with a user wearing the harness as the user traverses a length of the climbing surface, the fall arrest device is positioned substantially directly above the user throughout the user's climbing experience, ensuring that if the user falls, the descent will occur in a safe and controlled manner.

The present application claims priority to U.S. Provisional Patent Application 62/743,643, filed on Oct. 10, 2018, the entirety of which is incorporated by reference herein.

### BACKGROUND OF THE INVENTION

At present, there are few, if any, climbing walls configured to be enjoyed by disabled persons. The present disclosure describes a climbing wall that includes a track-based support harness that provides an opportunity for disabled persons, as well as non-disabled persons, to utilize a climbing wall.

### SUMMARY OF THE INVENTION

Embodiments of the present invention are directed to a climbing wall comprising a climbing surface and a climbing assistance assembly that provides a disabled child with an opportunity to utilize the climbing wall.

The climbing assistance assembly comprises a track mounted above at least a portion of the climbing surface and spanning at least a portion of the length of the climbing surface. A trolley, from which a rope is suspended, is configured to travel along the track. In some embodiments, the trolley may be configured to provide enhanced stability, such as through the inclusion of rolling elements (e.g. wheels) that interact with the track across two planes. For instance, the trolley may comprise a first wheel or set of wheels that ride on an upward-facing surface of the track and a second wheel or set of wheels that ride on a substantially vertical, side surface of the track.

The rope may be coupled both to the trolley and to a harness. The climbing assistance assembly may further include a fall arrest device configured to lower the end of the rope that is coupled to the harness from an elevated position to a rest position in a controlled manner. Because the trolley is configured to travel with a user wearing the harness as the user traverses a length of the climbing wall, the fall arrest device is positioned substantially directly above the user throughout the user's climbing activity, ensuring that if the user falls at any time during that climbing activity, the descent will occur in a safe and controlled manner. In some embodiments, the assembly may comprise a first rope comprising the fall arrest device and a second static rope that serves as a backup measure.

In some embodiments, the track may be mounted to the climbing wall or a support wall by a plurality of mounting brackets. The mounting brackets may be configured to fold up against the wall so that the track may be moved between a use position and a storage position. In some embodiments, the mounting brackets may even be locked in the storage position in order to prevent un-permitted use of the climbing assistance assembly. The mounting brackets may also be configured so that the track can be mounted at a desired position relative to the climbing wall or support wall. For instance, in some embodiments, the mounting brackets may comprise a plurality of track mounting points.

### BRIEF DESCRIPTION OF THE DRAWINGS

A clear conception of the advantages and features of one or more embodiments will become more readily apparent by reference to the exemplary, and therefore non-limiting, embodiments illustrated in the drawings:

FIG. 1 is a perspective view of a track and trolley assembly in accordance with an embodiment of the present disclosure.

FIG. 2 is a front elevation view of the track and trolley assembly of FIG. 1, showing the detail of the trolley and track interface.

FIG. 3 is a perspective view of a climbing wall assembly in accordance with an embodiment of the present disclosure, showing movement of a trolley across a track that spans adjacent walls.

FIG. 4 is a perspective view of a climbing wall assembly in accordance with an embodiment of the present disclosure, showing movement of a trolley across a track that spans adjacent walls and in particular showing a curved portion of the track.

FIG. 5 is a perspective view of a track and trolley assembly in accordance with an embodiment of the present disclosure, showing the track suspended by a mounting bracket and showing connectors that can be used to attach individual track segments together to form a continuous track.

FIG. 6A is a perspective view of a mounting bracket in accordance with an embodiment of the present disclosure, showing the hanger arm in an extended position.

FIG. 6B is a perspective view of the mounting bracket of FIG. 6A, showing the hanger arm locked in an upright, storage position.

FIG. 6C is an exploded perspective view of the mounting bracket of FIGS. 6A and 6B, showing the various components thereof.

FIG. 7 is a perspective view of a track and trolley assembly in accordance with another embodiment of the present disclosure.

FIG. 8 is a front elevation view of the track and trolley assembly of FIG. 7, showing the detail of the trolley and track interface.

FIG. 9 is a top plan view of the track and trolley assembly of FIG. 7.

FIG. 10 is a side elevation view of the track and trolley assembly of FIG. 7.

FIG. 11 is a perspective view of a belay in accordance with an embodiment of the present disclosure.

FIG. 12 is a perspective view of a harness in accordance with an embodiment of the present disclosure.

FIG. 13 is a perspective view of an ascender in accordance with an embodiment of the present disclosure.

FIG. 14 is a perspective view of a climbing wall assembly having a climbing assistance unit in accordance with an embodiment of the present disclosure.

### DETAILED DESCRIPTION OF THE INVENTION

For purposes of the present disclosure, the terms climbing wall and climbing surface should be considered to include climbing walls containing predominantly vertical climbing surfaces as well as climbing walls containing predominantly horizontal climbing surfaces, which may be referred to commercially as a Traverse Wall®. Some climbing walls, and especially Traverse Walls®, may also include various activities in addition to climbing, such as various obstacles that must be traversed over, around, or through (e.g. hoops); monkey bars or similar elements; rope elements; swinging (or otherwise movable) elements that must be traversed using one's hands and/or feet; cargo net elements; and the like.

The climbing wall or climbing surface may comprise both (1) a height and (2) a width or length. In general, a climbing wall comprising a predominantly vertical climbing surface may be referred to as having a (horizontal) width whereas a climbing wall comprising a predominantly horizontal climbing surface may be referred to as having a (horizontal) length. However, for purposes of the present disclosure, those terms are used interchangeably. In other words, reference to a climbing wall length for example should be considered no different than a reference to a climbing wall width and does not specifically refer to any particular type of climbing wall.

Embodiments of the climbing wall assembly 100 of the present disclosure comprise a climbing surface 101 having a plurality of climbing grips 102 and a climbing assistance unit 10. As explained above, the climbing surface 101 may be oriented predominantly vertically or predominantly horizontally, or it may have similar or variable height and width dimensions. The climbing assistance unit 10 is made up of a number of elements, including at least a track 11; a trolley 12; one or more ropes 13; one or more fall arrest devices, such as an auto-belay 14 and/or an ascender 16; and a harness 15.

The track 11 is mounted above at least a portion of the climbing surface 101. For instance, in some embodiments the track 11 may be mounted to the top of a climbing wall. In other embodiments, the track 11 may be mounted to a ceiling or support wall in the vicinity of the climbing surface 101. The track 11 spans a length of the climbing surface 101. This does not mean that the track 11 must necessarily span the entire length of the climbing surface 101. Rather, in some embodiments, the length of the climbing surface 101 spanned by the track 11 may be less than the full side-to-side dimension of the climbing surface. In other embodiments, the length of the climbing surface 101 spanned by the track 11 may be the entire length of the climbing surface. In some embodiments, for instance, the ends of the track 11 may correspond with the side edges of the climbing surface 101 or may be located beyond the side edges of the climbing surface. The track 11 may comprise a plurality of individual track units placed next to one another, each track unit being affixed to each adjacent track unit, to create a continuous track having a desired length.

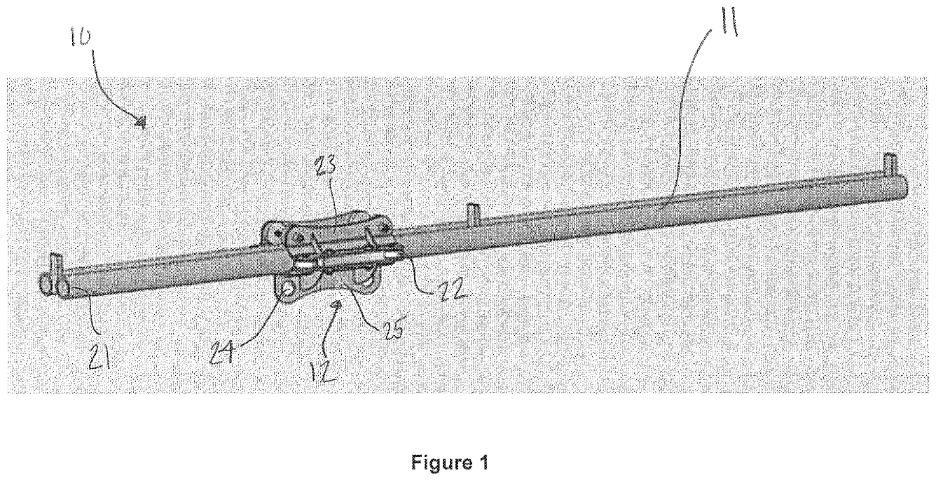

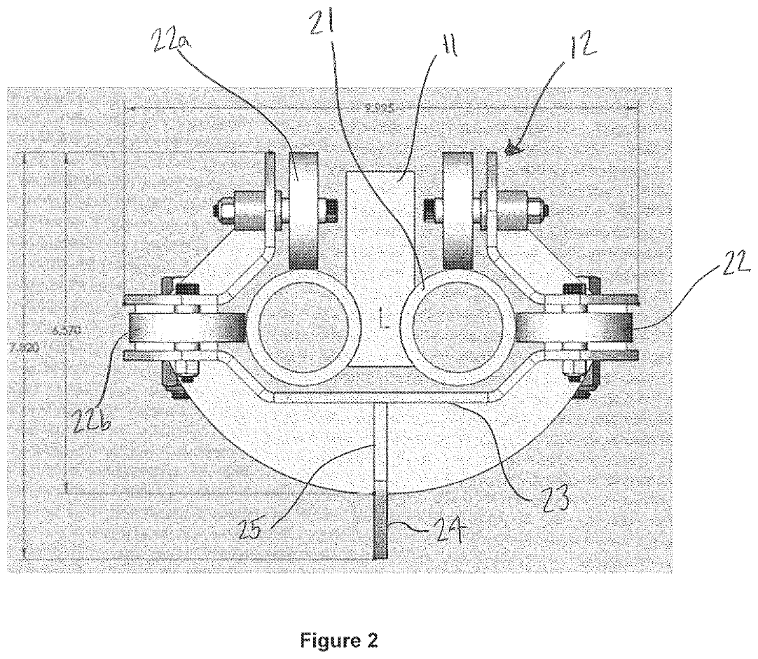

The track 11 may take on any of a variety of configurations. An embodiment of a track 11 is shown in FIGS. 1 and 2. In the illustrated embodiment, the track 11 comprises a pair of round tubes 21 designed to be suspended from either a ceiling or a mounting bracket 40 (which may be affixed to a support wall). In an alternative embodiment, the track 11 may comprise a pair of round tubes 21 designed to be directly attached to a support wall, e.g. a portion of a wall above a climbing surface 101. Each of the round tubes 21 is configured for the wheels 22 of a trolley 12 oriented in two opposing planes to roll along the length of the tube. For instance, as shown in FIG. 2, a first wheel 22a of a trolley 12 may roll along the top of (i.e. above) a round tube 21 and a second wheel 22b of a trolley may roll along the outer side of that round tube.

The trolley 12 is configured to travel along at least a portion of the track 11. For instance, the trolley 12 may have a plurality of wheels 22 that roll along one or more surfaces of the track 11. For example, the trolley 12 may have a first set of wheels 22a that roll along an upward-facing surface of the track 11. In some embodiments, the trolley 12 may also have a second set of wheels 22b that rolls along a different surface of the track 11, such as a vertical wall of the track. By providing a trolley 12 having wheels 22a, 22b oriented in two different planes and configured to travel along non-parallel (e.g. perpendicular) surfaces, for instance, the trolley may be provided with enhanced stability. This may be of particular benefit here, where the forces being placed on the trolley 12 from a user may be strong and in variable directions.

An embodiment of a trolley 12 is shown in FIGS. 1 and 2. In the illustrated embodiment, the trolley 12 comprises a first set of wheels 22a configured to roll along the top surface of the round tubes 21 that form part of the track 11 and a second set of wheels 22b configured to roll along the outer surface of those round tubes. This provides the trolley 12 with a significant degree of stability to withstand forces in multiple directions, as is to be expected in a climbing application. The trolley 12 also comprises a base 23, to which the first and second sets of wheels 22a, 22b are attached. The base 23 is designed to extend across the bottom of the track 11 and substantially around the sides of the track. For instance, the base 23 extends from a point above the first side of a track 11, around the underside of the track, and up to a point above the second side of the track. A portion of the trolley 12 that travels underneath the track 11 comprises an attachment location 24 for a rope 13. In the illustrated embodiment, for instance, the trolley 12 comprises a fin 25 that extends downward from the base 23 and that comprises a pair of rope attachment apertures 24. Although not illustrated, the trolley 12 may also comprise a housing, e.g. a molded plastic cover, that will eliminate pinch points.

The rope 13 is configured to support a user from the trolley 12. As used herein, the term rope 13 should be considered to include cords, cables, lanyards, and any other types of line that may be used for climbing. A first end of the rope 13 is affixed to the trolley 12 and a second end of the rope is configured to couple to a harness 15. In some embodiments, for instance, a second end of the rope 13 may comprise a clip 18, such as a carabiner, for coupling to a mounting element 17, e.g. a ring, on a harness 15. The rope 13 may comprise one or more elements that provide for adjustment of the rope length, such as a cam buckle, a ratchet buckle, or the like.

In some embodiments, the assembly 10 may comprise a plurality of ropes 13. For instance, in one embodiment, the assembly 10 may comprise a first rope 13a configured to operate with an auto-belay 14 during a climbing activity and a second rope 13b having a fixed length during the climbing activity. In this way, the second rope 13b may act as a backup safety measure. In some embodiments, the length of the first rope 13a, the second rope 13b, or both may be fixed to correspond with a particular user prior to the beginning of climbing. In some embodiments, for instance, the second rope 13b may be configured to operate with an ascender 16, which can be manually set to provide the rope with a desired fixed length. In some embodiments, the assembly 10 may only comprise a single rope 13, e.g. one of rope 13a configured to operate with an auto-belay 14 and rope 13b configured to operate with an ascender 16.

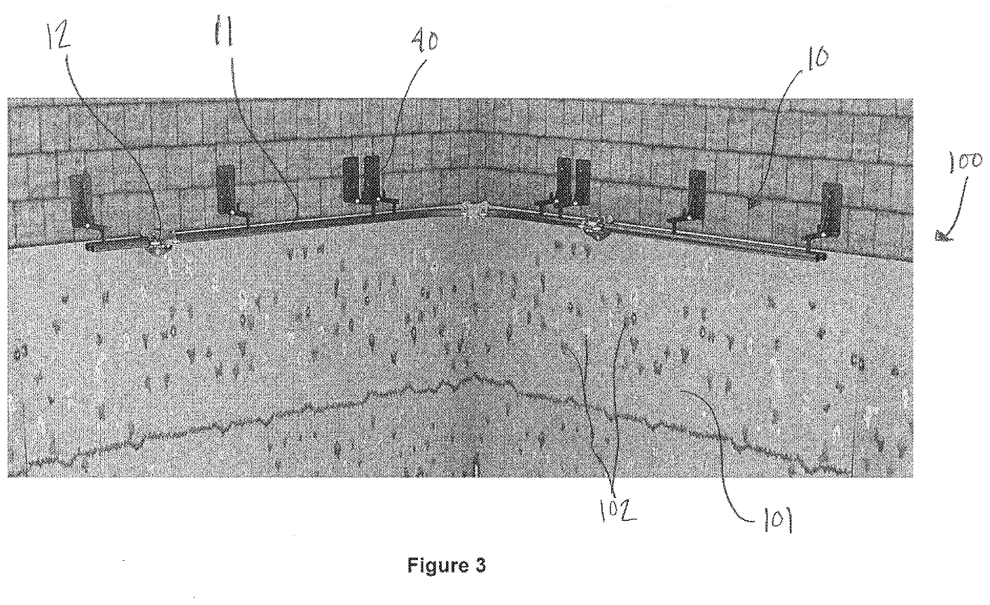

Each of the first and second ropes 13 may be attached to the trolley 12, such as through the illustrated pair of rope attachment apertures 24. Another embodiment of a trolley 12 is shown in FIGS. 3-5. The trolley 12 shown in FIGS. 3-5 is substantially identical to that shown in FIGS. 1 and 2, except that it comprises only a single rope attachment aperture 24. Although not illustrated, a plurality of ropes 13 may be attached to the single rope attachment aperture 24 of the trolley 12. For example, each of the first and second ropes 13 described above may be attached to the single rope attachment aperture 24. In this manner, all forces placed on the trolley 12 by a user will be directed to a single, preferably central, point on the trolley 12 (from which they can be dispersed into the trolley body 23).

The assembly 10 may also comprise a fall arrest device, such as an auto-belay 14, that is configured to lower the second end of the rope 13, and hence a user wearing a harness 15 to which the second end of the rope is attached, from an elevated position to a rest position in a controlled manner. In this way, as a user drops from an elevated position, the auto-belay 14 will control the user's descent, ensuring a safe landing on the ground. In some embodiments, the auto-belay 14 of the present assembly may provide a slower, i.e. more controlled, descent than a conventional auto-belay in order to provide a more comfortable landing for a disabled person. It may also be desirable to adjust the length of the rope 13 to correspond with a supported standing position of a user prior to use of the climbing surface 101, since some users may have limited ability to stand on their own.

An example of an auto-belay 14 of the sort that may be included in the climbing assistance assembly 10 is shown in FIG. 11. In some embodiments, such as that illustrated in FIG. 11, the auto-belay 14 may be configured to attach directly to the trolley 12, and more particularly to a rope attachment aperture 24 of the trolley. In other embodiments, the auto-belay 14 may be configured to attach directly to the harness 15, and more particularly to a mounting element 17 of the harness or to be positioned between the first and second ends of the rope 13a. As shown in the illustrated embodiment, the auto-belay 14 may be configured to receive a length of the rope 13a within a body. When a strong downward force is placed on the rope 13a, such as when a climber falls from a climbing surface 101, the auto-belay 14 may control movement of the rope 13a through the outlet of the body, thereby providing the climber with a controlled descent.

The assembly 10 may also comprise a fall arrest device, such as ascender 16, configured to provide a climber with a minimum fall elevation, i.e. an elevation below which a climber will not fall. The ascender 16 may be configured to receive rope 13b in a manner such that an operator may assist a climber in obtaining a certain elevation (e.g. by pulling up on a free end of rope 13b to lift the climber) and then secure rope 13b to the ascender so as to create a minimum fall elevation. Once rope 13b is secured by the ascender 16, for instance, the length of rope between the trolley 12 and the harness 15 becomes fixed, limiting the downward travel of the harness and providing a climber with a minimum fall elevation. When a climber is back at the minimum fall elevation, the ascender 16 may be operated to release rope 13b, e.g. by again pulling on the free end of the rope.

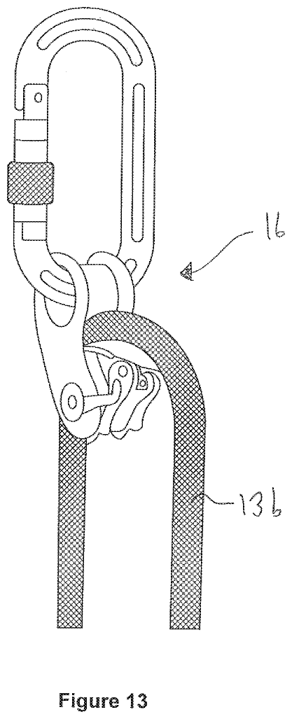

An example of an ascender 16 is shown in FIG. 13. In some embodiments, such as that illustrated in FIG. 13, the ascender 16 may be configured to attach directly to the trolley 12, and more particularly to a rope attachment aperture 24 of the trolley. In this way, for instance, an operator may bring a climber to desired minimum fall elevation, e.g. a fully standing elevation or slightly above fully standing elevation, and then secure the ascender 16 to rope 13b to fix the length of rope between the ascender 16 and harness 15. When used in combination with rope 13a and the associated auto-belay 14, a climber that falls from climbing surface 101 will be provided with a controlled descent (due to control of rope 13a) until rope 13b reaches the fixed minimum fall elevation, at which point the climber will stop descending.

In some embodiments, the ascender 16 may also be operated to assist a climber during the climbing activity. For instance, by pulling on free end of rope 13b, an operator may help a climber obtain a higher elevation. By careful control of rope 13b, an operator may also manually provide the climber with a controlled descent (in addition to or in the absence of rope 13a and the associated auto-belay 14).

Depending on the physical abilities of the climber, the climbing assistance assembly 10 may be operated either (a) using only rope 13a and the associated auto-belay 14 or (b) using only rope 13b and the associated ascender 16.

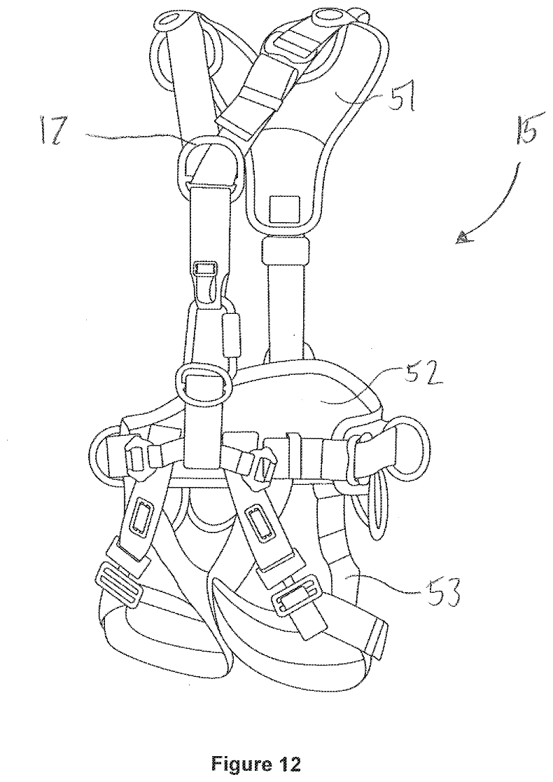

The assembly 10 may also comprise a harness 15 configured to be worn by a user and which may suspend the user from the trolley 12 using one or more ropes 13. An example of a harness 15 for use in the climbing assistance assembly 10 is shown in FIG. 12. As illustrated, the harness 15 is desirably configured to wrap around at least the legs and chest of a user in order to secure the user into the harness and prevent injury. For instance, the harness 15 may comprise a shoulder portion 51, a torso (or waist) portion 52, and a leg portion 53. The shoulder portion 51 may be configured to be placed over the shoulders of a user and to attach to the torso portion 52. The leg portion 53 may be configured to extend around the back of the thighs of a user and to attach to the torso portion at or near the waist. The harness 15 may also provide additional support for a climber, e.g. to a climbers legs, during a climbing activity.

In some embodiments, the harness 15 may be configured to be placed on a user while the user is in a sitting position. In this way, the harness 15 may be placed on a user sitting in a wheelchair or other mobility assistance device. For instance, in some embodiments, the shoulder portion 51 and the leg portion 53 of the harness may each be unattached from the front of the torso portion 52. Thus, the rear support of the torso portion 52 may be slide behind a user in a sitting position and each of the shoulder portion 51 and leg portion 53 may then be appropriately placed on the user and attached to the front of the torso portion, e.g. through clips or the like, without requiring any particular movement from the user.

The harness 15 comprises one or more mounting elements 17 for attachment the ropes 13. In some embodiments, a mounting element 17 may be placed on the portion of the harness 15 that is located on the front of a user, e.g. at the chest or abdomen of the user. In some embodiments, a mounting element 17 may also be placed on the portion of the harness 15 that is located on the back of a user. For instance, first rope 13a may be attached to a mounting element 17 located on the front of the harness 15 and a second rope 13b may be attached to a mounting element located on the rear of the harness. In other embodiments, both ropes 13a, 13b may be attached to a one or more mounting elements 17 located on the front of the harness 15.

In some embodiments, the assembly 10 may also comprise a grab bar that is configured to assist a user in moving from a sitting position, e.g. a user sitting in a wheelchair or other mobility-assistance device, to a standing position. The grab bar may be located in any of a variety of locations, including for instance on the climbing surface 101 itself or on a wall, e.g. a support wall, adjacent to the climbing surface. When the user is ready to begin climbing, e.g. after the user has secured the harness 15, the user may use the grab bar to pull him or herself out of a sitting position and up to the climbing surface 101.

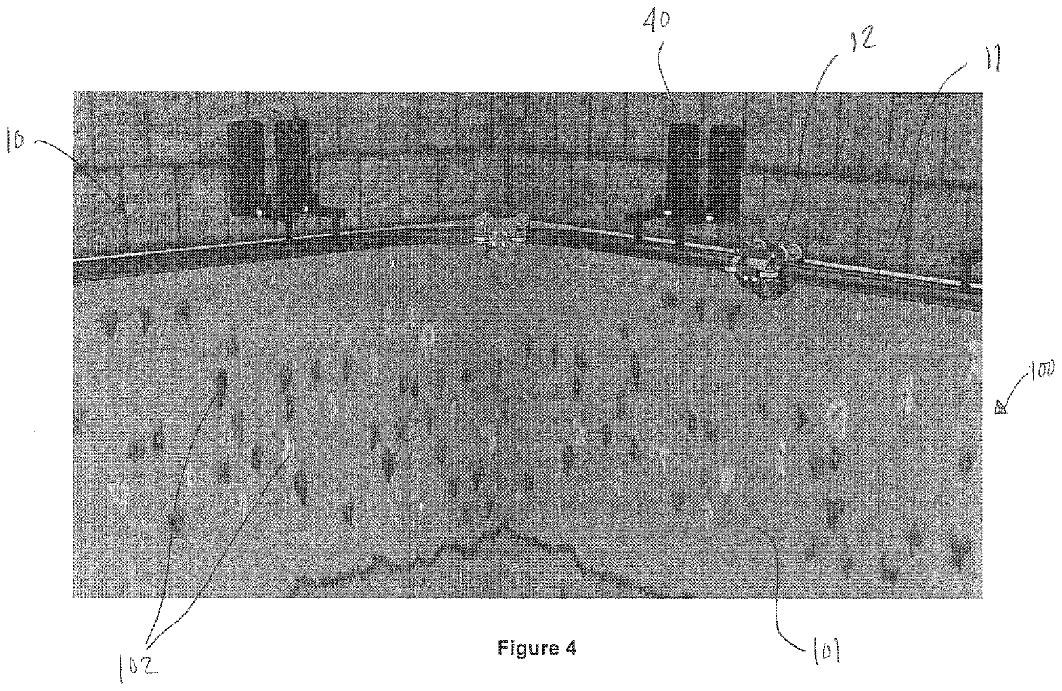

An embodiment of a climbing wall assembly 100 including a climbing surface 101, track 11, and trolley 12 is illustrated in FIGS. 3-4. The track 11 is mounted to a support wall by a plurality of mounting brackets 40, which suspend the track above the climbing surface 101 at a desired distance from the support wall (for example between about 6 inches and 14 inches, alternatively between about 8 inches and about 12 inches). As illustrated, the track 11 is also positioned at or near the top edge of the climbing surface 101, though the track could also be positioned higher up on the support wall in order to ensure that climbers do not grab the track or interfere with movement of the trolley 12 along the track.

Notably, the climbing surface 101 shown in FIGS. 3 and 4 spans across two adjacent walls, such as two adjacent and perpendicular walls. The track 11 is shown as including a curved portion which provides for a continuous track across the adjacent walls. Accordingly, the trolley 12 may seamlessly travel back and forth between the adjacent walls as a climber traverses between the two walls. Movement of the trolley 12 through the curved portion of the track 11 and between the adjacent support walls is shown in FIGS. 3 and 4.

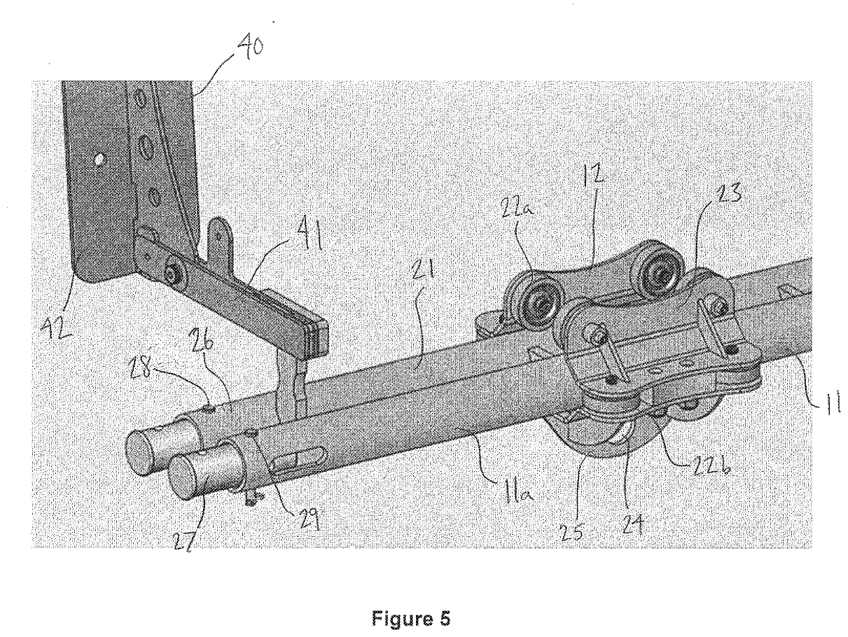

In some embodiments, the track 11 may be made up of a plurality of independent track segments 11a, 11b which together form a continuous or substantially continuous surface(s) on which the trolley 12 may travel. Each track segment 11a may be connected to an adjacent track segment 11b in any of a variety of manners. One such manner is shown, for example, in FIG. 5. Specifically, in the embodiment of the track 11 illustrated in FIG. 5, a first track segment 11a comprises an open end 26. For example, the track segment 11a may be a hollow tube or the track segment may simply include an end portion comprises a hollow tube. Similarly, a second track segment 11b (not illustrated) may also comprise an open end. A connector 27 may be inserted into the open end 26 of the first track segment 11a and secured therein. The connector 27 may be secured therein in a number of ways. For instance, the connector 27 could be secured within the open end 26 of the first track segment 11a by one or more fasteners, e.g. bolts, screws, etc., which could pass through apertures in the first track segment and the connector.

In the illustrated embodiment, the connector 27 comprises one or more push-buttons 28 that are biased into an extended position and the track segment 11a comprises one or more apertures 29 positioned to align with the one or more push-buttons when the connector is sufficiently inserted into the open end 26 of the track segment. Insertion of the connector 27 into the open end 26 of the track segment 11a will case the push button 28 to depress (by way of contact with an inner surface of the track segment). Once the connector 27 is inserted to a predetermined extent, however, the push-button 28 will align with the aperture 29 in the track segment 11a, at which point it will pop back out to its extended state and enter the aperture, securing the connector in place. If one wishes to remove the connector 27, one would need to push down on the one or more push-buttons 28 and pull the connector out of the open end 26 of the track segment 11a. Each of the first and second track segments 11a, 11b may be secured to the connector 27 in the same manner.

Additionally, in some embodiments, any of the track segments 11a, 11b may be converted to an end of the track 11. For instance, each track segment 11a, 11b may be configured to receive a trolley stop element. The trolley stop element may be inserted into the open end 26 of the track segment 11a, 11b in a similar manner as the connectors 27 described above. Alternatively, the trolley stop element may be a pin, rod, bolt, or the like that may be inserted through one or more apertures 29 in the surface of the track segment 11a, 11b. By having each track segment 11a, 11b configured to either be connected to an adjacent track segment or form an end of the track 11, tracks of varying length may be formed from the same set of track segments. Further, an existing track 11 may be easily modified to either extend or shorten the track as may be desired, such as to coincide with a change to the length of the climbing surface 101.

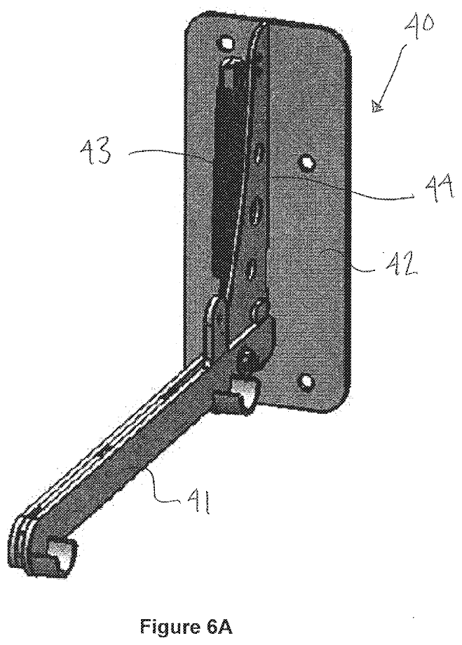

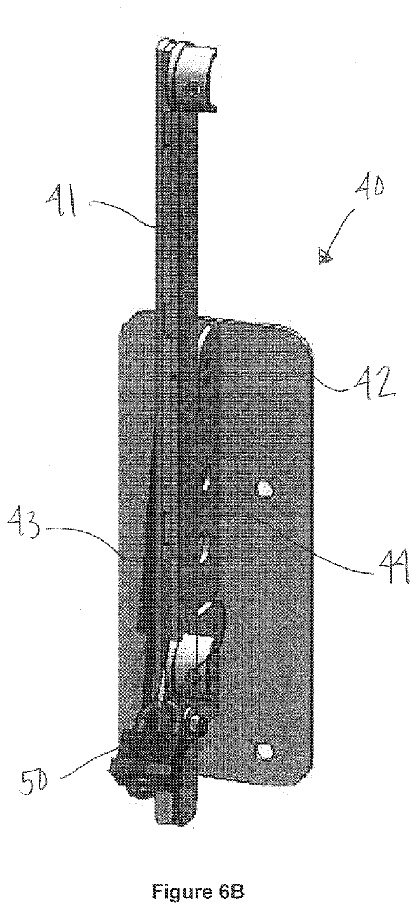

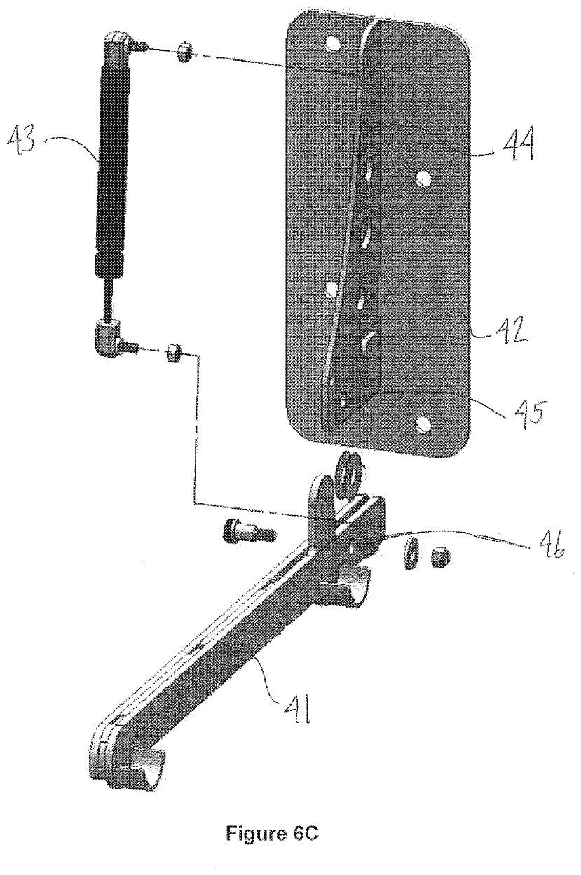

Also shown in FIG. 5 is a mounting bracket 40 that is configured to attach to a support wall and suspend the track 11a desired distance from the support wall. Another embodiment of a mounting bracket 40 is shown in FIGS. 6A through 6C. The mounting bracket 40 shown in FIGS. 6A through 6C has the additional benefit that it can be folded up against the support wall, thereby storing the track 11 against the support wall and preventing its unsupervised and/or unintended use. Storage of the track 11 against the support wall in this manner may also prevent users of the climbing surface 101 from grabbing onto the track 11, pushing the trolley 12 along the track, or otherwise operating the climbing assistance unit 10 in an unintended manner.

In particular, the mounting bracket 40 shown in FIGS. 6A through 6C comprises a hanger arm 41 that is coupled to a base plate 42 by way of one or more actuators 43. The one or more actuators 43 may comprise, for example, a pneumatic linear actuator, a hydraulic linear actuator, an electric linear actuator, a ball screw actuator, or the like. In the illustrated embodiment, for instance, the actuator 43 is a gas spring. In another embodiment, the mounting bracket 40 may also comprise a second gas spring positioned on the opposite side, i.e. to the right of the base plate fin 44. In some embodiments, including for example the illustrated embodiment, the actuator 43 may be operated manually, such as by pushing upward on the track 11 or the arm 41 (to bring the arm from an extended position to an upright position) or pulling down on the track or the arm (to bring the arm from an upright position to an extended position). In other embodiments, the actuators 43 for the plurality of mounting brackets 40 may be electrically coupled to a button, switch, or the like which may be used to activate the actuators so as to move the arms 41 between extended and upright positions, i.e. so as to move the track 11 between a use position and a storage position.

The mounting bracket 40 is preferably configured so that the hanger arm 41 (and the track 11 that is coupled thereto) may be maintained in a stored, i.e. upright, position. For instance, when the track 11 is rotated upward into its stored position, the actuator 43 will hold the hanger arm 41 in the upright position and the weight of the track will not cause it to rotate back down into an extended position. In some embodiments, the hanger arm 41 may also be locked in an upright position, such as through the use of a conventional padlock 50, as is shown in FIG. 6B. For instance, each of the base plate 42 and the hanger arm 41 may comprise an aperture 45, 46 sized and configured to receive a conventional padlock 50. In this way, one may lock the track 11 in a stored position to ensure that the climbing assistance unit 10 is not improperly used.

Embodiments of the presently disclosed climbing wall assembly 100 provide a fall arrest device that travels with a climber as the climber traverses a length of the climbing surface 101. This allows disabled children or children having limited physical abilities to utilize the climbing wall 100 without fear of injury. For instance, the climbing assistance unit 10 ensures that if a disabled child loses grip or otherwise falls from the climbing surface 101, the child will not fall directly to the ground but will rather be lowered to a preselected position in a slow, controlled manner. The climbing wall assemblies 100 disclosed herein thus offer climbing opportunities that might not otherwise be possible for a disabled child.

Moreover, using embodiments of the presently disclosed climbing wall assembly 100, a disabled child or a child having limited physical abilities may be able to enjoy a climbing experience that is extremely similar to that of a non-disabled child. Because there is little to differentiate those climbing experiences, the climbing wall assembly 100 will promote inclusive play in which disabled children are provided the same or substantially the same play opportunities as non-disabled children.

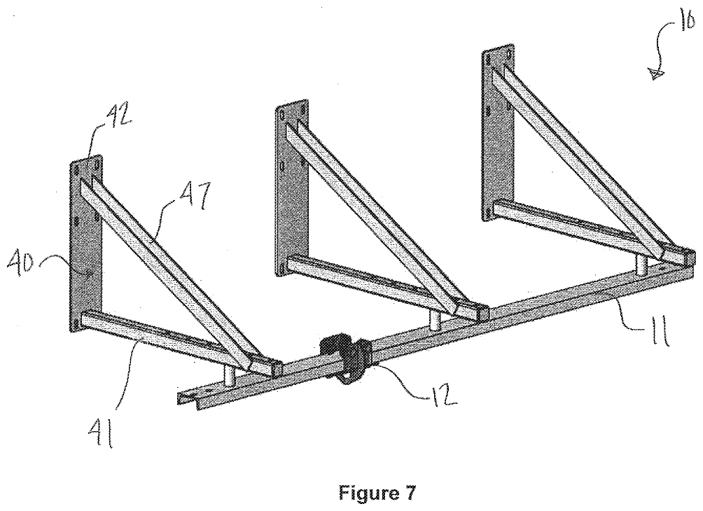

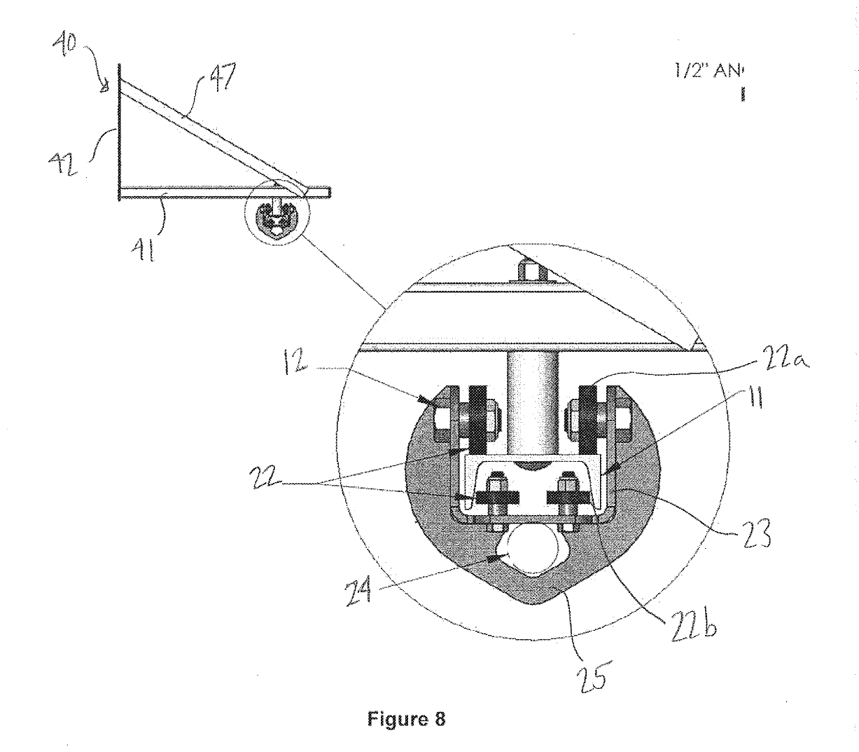

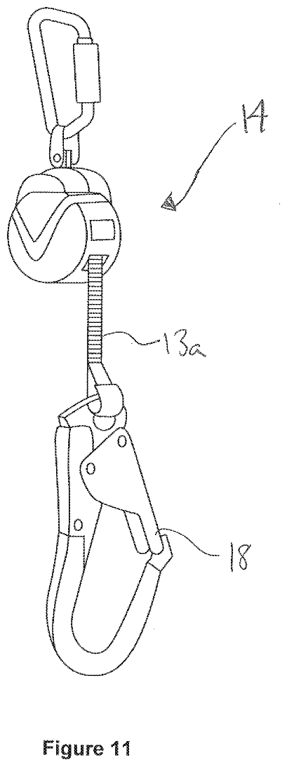

Another embodiment of a track 11 and trolley 12 assembly is shown in FIGS. 7 through 10. In this embodiment, the rounded tubes 21 shown in FIGS. 1-5 have been replaced with a U-shaped track 11. In order to move along the U-shaped track 11, the trolley 12 also has a slightly different configuration from that shown in FIGS. 1-5. As with that shown in FIGS. 1-5, the trolley 12 shown in FIGS. 7-10 comprises wheels 22, a base 23, a fin 25 that extends downward from the base 23, and a rope attachment aperture 24. Unlike that shown in FIGS. 1-5, the wheels 22 of the trolley 12 interact with different surfaces of the track 11. Specifically, the trolley 12 comprises a first set of wheels 22a configured to roll along the top surface of the U-shaped track 11 and a second set of wheels 22b configured to roll along the inner side surfaces of that U-shaped track. As with the multi-plane wheels of the previous embodiment, this provides the trolley 12 with a significant degree of stability to withstand forces in multiple directions, as will occur in a climbing application.

The mounting brackets 40 shown in FIGS. 7 through 10 also differs from those shown in FIGS. 1-6. As with that shown in FIGS. 1-6, the mounting bracket 40 shown in FIGS. 7-10 comprises an arm 41 and a wall plate 42. The mounting bracket 40 also comprises a pair of stability-enhancing members 47, which span between the arm 41 and the wall plate 41. In the illustrated embodiment, a first end of structural support members 47 is attached to the distal end of the arm 41 and a second end of structural support members is attached to the upper portion of the wall plate 42, although other configurations are also contemplated without departing from the scope of the present disclosure.

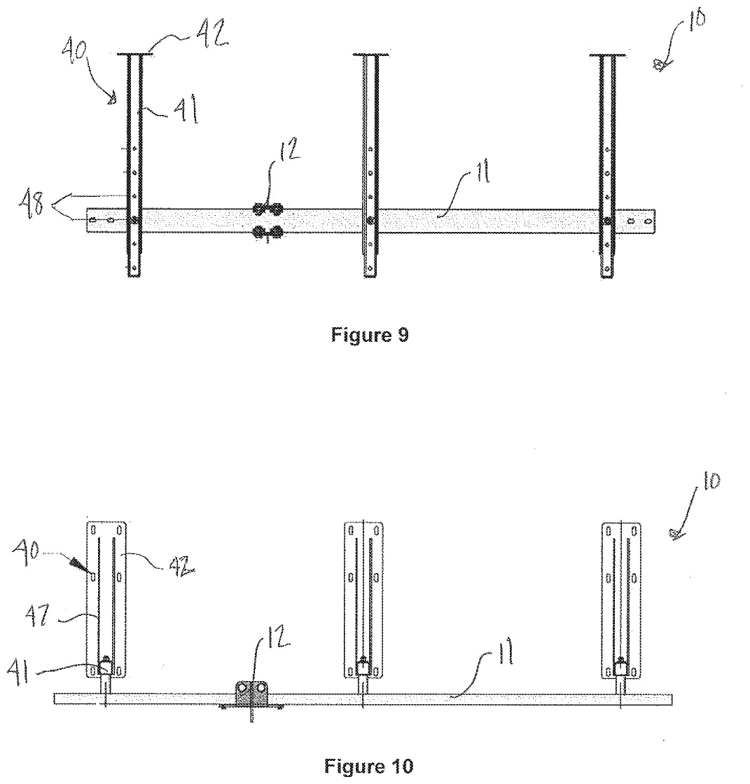

The arm 41 of the mounting bracket 40 may also comprise a plurality of track mounting points 48, as illustrated for example in FIG. 9. The inclusion of multiple track mounting points 48 allows for the mounting of track 11 at a plurality of different distances from the support wall.

In the illustrated embodiment, for example, the arm 41 of mounting bracket 40 comprises a first track mounting point 48 at a distance of about 16 inches from the wall plate 42, a second track mounting point at a distance of about 20 inches from the wall plate, a third track mounting point at a distance of about 24 inches from the wall plate, a fourth track mounting point at a distance of about 28 inches from the wall plate, a fifth track mounting point at a distance of about 32 inches from the wall plate, and a sixth track mounting point at a distance of about 36 inches from the wall plate. The arm 41 may comprise any number of track mounting points 48, however, and each track mounting point may be separated from each adjacent track mounting point by any desired distance. For example, in some the track mounting points 48 may be located in two-inch increments, four-inch increments, five-inch increments, six-inch increments, or the like.

Moreover, in some embodiments, the arm 41 is configured to allow for mounting of a track 11 at a variety of different distances within the range of 8 inches to 48 inches from the support wall, alternatively within the range of 12 inches to 42 inches from the support wall, alternatively within the range of 16 inches to 36 inches from the support wall, alternatively within the range of 18 inches to 34 inches from the support wall, alternatively within the range of 20 inches to 32 inches from the support wall.

As illustrated, the mounting brackets 40 may be spaced apart from one another along the length of the track 11 as needed to provide structural support and stability.

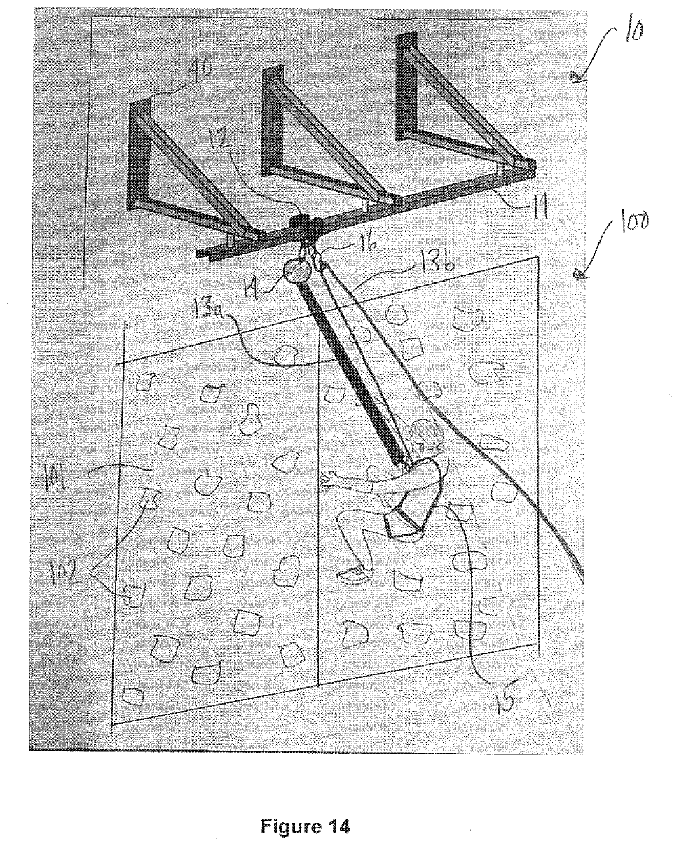

An embodiment of the climbing wall assembly 100 is shown in FIG. 14. In the illustrated embodiment, a climber is shown wearing a harness 15. The harness 15 is attached to trolley 12 through each of a first rope 13a and a second rope 13b. The first rope 13a comprises an auto-belay 14, which is operable as described herein. The second rope 13b comprises an ascender 16, which is operable as described herein. The trolley 12 is operable to slide along a track 11 mounted above and along a length of climbing surface 101, in order to maintain the auto-belay 14 and the ascender 16 substantially directly above the climber during the climbing activity.

It can be seen that the described embodiments provide a unique and novel climbing wall assembly that has a number of advantages over those in the art. While there is shown and described herein certain specific structures embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A climbing wall assembly comprising:
a climbing surface comprising a plurality of climbing grips; and
a climbing assistance unit comprising
a track mounted above at least a portion of the climbing surface and spanning a length of the climbing surface;
a trolley configured to travel along the track;
a harness configured to be worn by a user;
a rope configured to be affixed both to the trolley and to the harness;
a fall arrest device configured to lower the harness from an elevated position to a rest position in a controlled manner;
wherein the trolley is configured to travel with a user wearing the harness as the user traverses a length of the climbing surface, such that the fall arrest device is positioned substantially directly above the user throughout the climbing activity.

2. The climbing wall assembly of claim 1, further comprising a grab bar configured to assist a user in moving from a sitting position to a standing position.

3. The climbing wall assembly of claim 2, wherein the grab bar is mounted on the climbing surface or on a wall adjacent to the climbing surface.

4. The climbing wall assembly of claim 1, wherein a portion of the harness configured to be located on the front of a user comprises a mounting element and wherein the rope is configured to attach to the mounting element.

5. The climbing wall assembly of claim 1, wherein the harness is configured to wrap around at least the legs and chest of a user.

6. The climbing wall assembly of claim 1, wherein the harness is configured to be placed on a user in a sitting position.

7. The climbing wall assembly of claim 1, wherein the trolley has a first set of wheels that travel on an upward-facing surface of the track and a second set of wheels that travel along one or more sidewalls of the track.

8. The climbing wall assembly of claim 7, wherein the one or more sidewalls of the track are vertical.

9. The climbing wall assembly of claim 1, wherein the trolley has a first set of wheels arranged vertically and a second set of wheels arranged horizontally.

10. The climbing wall assembly of claim 1, wherein the fall arrest device is an auto-belay.

11. The climbing wall assembly of claim 10, wherein a backup rope is also coupled to the trolley.

12. The climbing wall assembly of claim 11, wherein the backup rope comprises an ascender.

13. The climbing wall assembly of claim 1, wherein the climbing surface spans adjacent walls, and
wherein the track comprises a curved portion by which the trolley travels between the adjacent walls.

14. The climbing wall assembly of claim 1, wherein the track comprises a plurality of track segments connected together to form a substantially continuous surface on which the trolley may travel.

15. The climbing wall assembly of claim 14, wherein first and second track segments are connected by a connector element that is inserted into (i) an open end of the first track segment and (ii) an open end of the second track segment.

16. The climbing wall assembly of claim 14, wherein each track segment is configured to receive either the connector element or a trolley stop element.

17. The climbing wall assembly of claim 1, further comprising a plurality of mounting brackets that suspend the track from a support wall.

18. The climbing wall assembly of claim 17, wherein each of the plurality of mounting brackets is configured to fold up against the support wall.

19. The climbing wall assembly of claim 17, wherein each of the plurality of mounting brackets is configured such that the track can be mounted a plurality of different distances from the support wall.

20. The climbing wall assembly of claim 1, wherein the climbing surface is predominantly horizontal.
